(19) United States
(12) Patent Application Publication
(10) Pub. No.: US 2010/0103328 A1
(43) Pub. Date: Apr. 29, 2010

(54) MEDIA SIGNAL SINK AND METHOD FOR PLAYING IMAGE THEREOF

(75) Inventor: Myung Ho Jang, Gumi-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/522,532

(22) PCT Filed: Jan. 8, 2008
(86) PCT No.: PCT/KR08/00104

§ 371 Date: Dec. 15, 2009

(30) Foreign Application Priority Data
Jan. 9, 2007 (KR) 10-2007-0002475

(51) Int. Cl. H04N 9/64

(52) U.S. Cl. 348/720; 348/E09.037

(57) ABSTRACT

A method for operating a signal sink and a signal sink employing the method are provided, which allows the user to easily control the function of a device that is currently being performed at the signal sink, only through a functional key operation, without selecting the type of the device.

### TECHNICAL FIELD

The present invention relates to a method for operating a signal sink and a signal sink employing the method, and more particularly, to a method for operating a signal sink and a signal sink employing the method, which allows the user to easily control the function of a device that is currently being performed at the signal sink, only through a functional key operation, without selecting the type of the device.

### BACKGROUND ART

A High-Definition Multimedia Interface (HDMI) standard, which transmits digital video signals and digital audio signals through a single digital interface scheme having a bandwidth of 5 Gbps or greater, has been developed and released recently. The HDMI, which is a digital audio/video interface which can transmit uncompressed streams, provides an interface between a compatible digital audio/video source and a compatible digital audio/video monitor (for example, television).

While a function provided by any of a plurality of audio/video sources is being implemented on an audio/video monitor, the user can control a function provided by a desired source in the following manner.

A selection key (not shown) and function keys (not shown) are mounted on a remote control (not shown) which controls the audio/video monitor. The selection key is a key which the user presses in order to select a desired one of a various types of audio/video sources or devices. The function keys are keys which the user presses in order to control various functions of the selected source. Examples of the function keys include a play key, a stop key, and a pause key. The user operates the selection key to select a desired one of the plurality of audio/video sources connectable to the audio/video monitor. The user then operates the function keys to directly control the audio/video source without help of the audio/video monitor.

However, when the user desires to control a function of an audio/video source through the conventional technology, they face inconvenience of having to first determine the type of the audio/video source. In addition, all function keys for directly controlling audio/video source functions must be provided. Therefore, when a desired function key is not provided, the user cannot control the corresponding audio/video source function.

### DISCLOSURE

### Technical Problem

An object of the present invention devised to solve the problem lies on providing a method for operating a signal sink and a signal sink employing the method, which allows the user to easily control a function of an audio/video source that is being performed without selecting the type of the audio/video source.

### Technical Solution

In one embodiment of the present invention, provided herein is a method for operating a signal sink that is connected to one or more devices through an HDMI scheme, the method including receiving a function control command from a user; determining that a device providing a function, which is being currently performed at the signal sink, is a device to which the function control command is to be transmitted; and converting the function control command to a command readable by the determined device.

In another embodiment of the present invention, provided herein is a signal sink that is connected to one or more devices through an HDMI scheme, the signal sink including a user command input unit that receives a function control command from a user; and a main processor that identifies a device providing a function, which is currently being performed at the signal sink, in response to receiving the function control command, determines that the identified device is a device to which the function control command is to be transmitted, and converts the function control command to a command readable by the determined device.

### Advantageous Effects

The signal sink operation method and the signal sink according to the invention has an advantage in that the user can easily control the function of a device that is currently being performed at the signal sink through a simple functional key operation without selecting the type of the device.

### DESCRIPTION OF DRAWINGS

FIG. 1 schematically illustrates an entire system including a signal sink and devices;

FIG. 2 illustrates a structure of a signal sink according to an embodiment of the invention;

FIG. 3 schematically illustrates an external appearance of a remote control corresponding to a user command unit according to the embodiment of the invention;

FIG. 4 is a flow chart illustrating a method for operating a signal sink;

FIGS. 5A to 5C illustrate GUI screens;

FIGS. 6A to 6D illustrate how GUI screens are changed;

FIG. 7 is a flow chart illustrating a method for operating a signal sink; and

FIG. 8 is a flow chart illustrating a method for operating a signal sink according to the embodiment of the invention.

### DESCRIPTION OF REFERENCE NUMERALS OF MAIN PARTS OF THE DRAWINGS

100,500: signal sink 200-208,400: signal sources

402,506: main processor 404,508: auxiliary processor

406: HDMI transmitter 408,502: HDMI connection module

504: HDMI receiver 510: user command input unit

512: GUI screen generator 514: video/audio processor

### BEST MODE

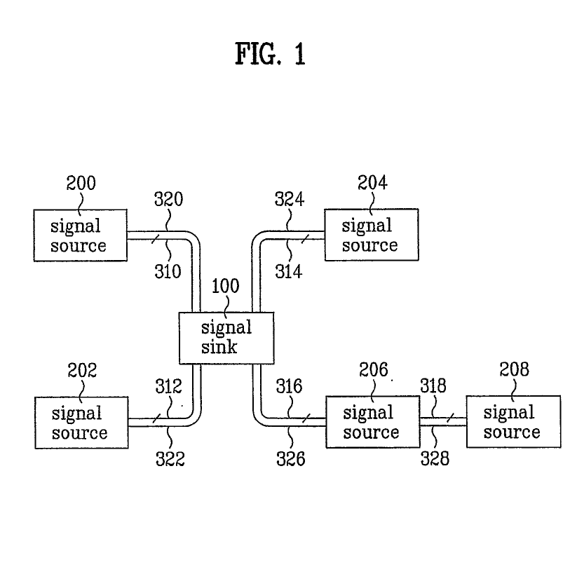

For better understanding of the invention, an entire system including at least one signal source and a signal sink will now be described with reference to FIG. 1.

FIG. 1 schematically illustrates an entire system including a signal sink and signal source. The system includes a signal sink 100, signal sources 200 to 208, HDMI lines 310 to 318, and HDMI-CEC (Computer Electronics Control) lines 320 to 328. More than or less than four signal sources can also be connected to the signal sink 100 although FIG. 1 shows that the four signal sources 200 to 208 are connected to the signal sink 100.

As shown in FIG. 1, the signal sink 100 receives and processes audio and/or video signals from the signal sources and then displays the processed results on a display device (not shown) or a monitor (not shown). Examples of the signal sink 100 which performs these functions include a video display device such as a television (TV), a projector, or a monitor.

Each of the signal sources 200 to 208 is capable of storing, reproducing, and/or processing an audio and/or video signal, and provides the audio and/or video signal to the signal sink 100 and can interface with the signal sink 100 through at least one physical port. Each signal source may include a plurality of devices. When a plurality of signal sources is connected as single hybrid equipment to the signal sink 100 through a single physical port, the description of the invention will be given upon the assumption that the hybrid device is a single signal source and each signal source included in the hybrid equipment is a device.

Examples of the signal source include a set top box (STB), a personal computer (PC), a video game system, a digital video disc (DVD) recorder, a hard disk drive (HDD) recorder which can be included in the STB or DVD recorder, and an audio/video source such as a home theater system (HTS) or a video cassette recorder (VCR).

The signal sink 100 is connected to the signal sources through the HDMI channel lines 310 to 318 and the HDMI-CEC lines 320 to 328 according to the HDMI scheme. The HDMI and CEC lines are composed of a single cable although the HDMI and CEC lines are separately shown for the sake of better understanding.

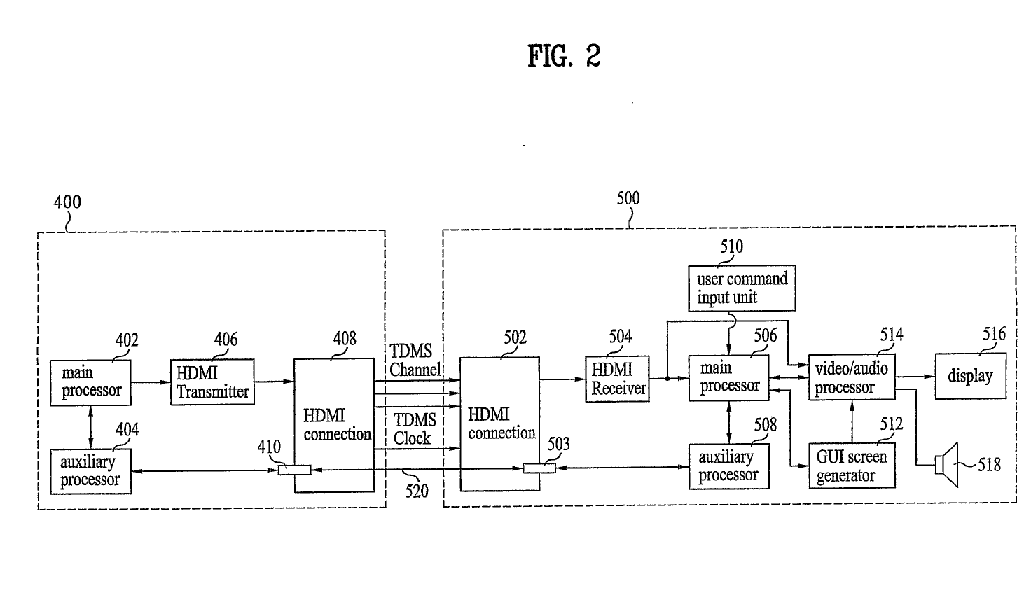

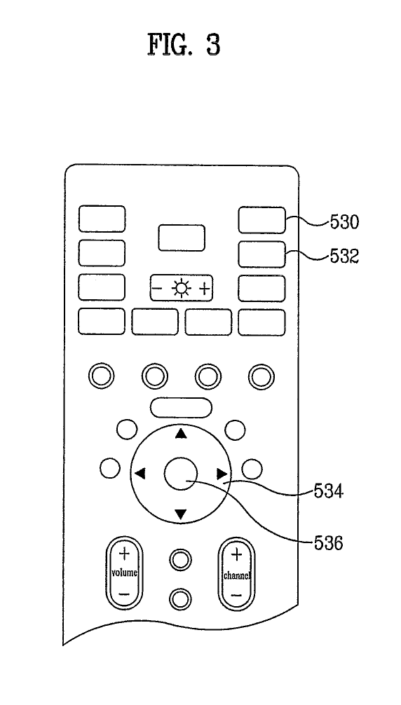

The configuration and operation of the signal sink 100 according to an embodiment of the invention will now be described with reference to FIGS. 2 and 3.

FIG. 2 illustrates a structure of the signal sink 100 according to the embodiment of the invention, which includes a signal source 400, a signal sink 500, and HDMI channel and HDMI-CEC lines 520.

The signal source 400, which corresponds to each of the signal sources 200 to 208 shown in FIG. 1, includes a main processor 402, an auxiliary processor 404, an HDMI transmitter 406, and an HDMI connection module 408. The signal sink 500 includes an HDMI connection module 502, an HDMI receiver 504, a main processor 506, an auxiliary processor 508, a user command input unit 510, a graphical user interface (GUI) screen generator 512, a video/audio processor 514, a display unit 516, and a speaker 518.

The auxiliary processor 404 transmits a CEC frame to the signal sink 500 through a pin 410 of the HDMI connection module 408 or receives a CEC frame transmitted from the signal sink 500 through the pin 410 and provides header and data blocks of the received CEC frame to the main processor 402. The auxiliary processor 508 transmits a CEC frame to the signal source 400 through a pin 503 of the HDMI connection module 502 or receives a CEC frame transmitted from the signal source 400 through the pin 503 and provides header and data blocks of the received CEC frame to the main processor 506.

A 13th pin of the HDMI connection module 408 or 502 can be allocated as the pin 410 or 503 when the HDMI connection module 408 or 502 is of A-type, a 22nd pin can be allocated as the pin 410 or 503 when it is of B-type, and a 14th pin can be allocated as the pin 410 or 503 when it is of C-type. Each of the auxiliary processors 404 and 508 can use interrupts, for example, at intervals of 0.1 ms for sampling CEC frames. Although the auxiliary processors 404 and 508 may be included in the main processors 402 and 506, respectively, it is preferable that the auxiliary processors 404 and 508 be provided separately from the main processors 402 and 506 since sampling at every 0.1 ms may add load to the operations of other components. In addition, each of the auxiliary processors 404 and 508 can perform a process for handling CEC line errors, a process for determining whether or not CEC frames are valid, and a process for retransmitting CEC frames.

Each of the main processors 402 and 506 can process a CEC protocol layer and an application layer. The CEC protocol layer, which is a middleware layer for implementing CEC protocol operations, provides a standard application programming interface (API) for developing applications. A porting layer may be provided taking into consideration changes of the hardware of the auxiliary processors 404 and 508. The main function of the CEC protocol layer is to construct and manage a device tree for the signal sink 500 and the signal sources 400. The CEC protocol layer also manages the status of each device. Particularly, the CEC protocol layer encapsulates the interior of the CEC protocol from applications.

The HDMI transmitter 406 of the signal source 400 receives audio/video data from the main processor 402 and transmits the audio/video data to the signal sink 500 through the HDMI connection module 408. Here, the audio/video data is transmitted according to a transition minimized differential signaling (TDMS) scheme which is also referred to as channel link. TDMS clocks are clocks for the TDMS scheme.

The HDMI receiver 504 of the signal sink 500 receives audio/video data transmitted from the signal sink 400 through the HDMI connection module 502 and outputs the received audio/video data to each of the main processor 506 and the video/audio processor 514. The user command input unit 510 is operated by the user to output an input user command to the main processor 506.

FIG. 3 schematically illustrates an external appearance of a remote control corresponding to the user command unit 510 according to the invention.

When the user command input unit 510 is implemented as a remote control, a hotkey 530, which is shaped like a button that is pressed by the user who requests that a GUI screen be displayed, may be provided on the remote control.

The main processor 506 controls the components 508, 512, and 514 of the signal sink 500. Under control of the main controller 506, the video/audio processor 514 performs audio and/or video signal processing of audio and/or video data received from the HDMI receiver 504, respectively. The video/audio processor 514 visually provides the video signal processing result to the user through the display unit 516 and audibly provides the audio signal processing result to the user through the speaker 518. Under control of the main processor 506, the GUI screen generator 512 generates a GUI screen and outputs the generated GUI screen to the video/audio processor 514. The video/audio processor 514 performs a process for combining the GUI screen generated by the GUI screen generator 512 with the video signal received from the HDMI receiver 504 and displays the combined GUI screen on the display unit 516.

The signal source 206 shown in FIG. 1 may itself process an audio/video signal received from the signal source 208 although the signal source 206 may transfer the audio/video signal received from the signal source 208 to the signal sink 100. That is, the signal source 206 can function as a signal sink for the signal source 208 if the signal source 206 has the components of the signal sink 500 shown in FIG. 2.

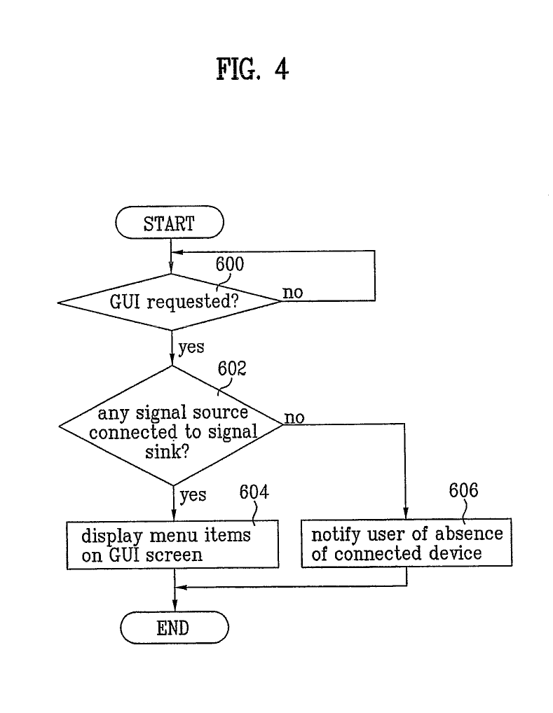

A method for operating a signal sink for providing GUI functions will now be described with reference to FIGS. 4 to 7. Although, for better understanding, the following description is given under assumption that the signal sink operating method is performed at the signal sink 500 shown in FIG. 2, the invention is not limited to this assumption.

FIG. 4 is a flow chart illustrating a method for operating a signal sink.

The main processor 506 determines whether or not a user command requesting a GUI for the user has been received from the user command input unit 510 (600). Here, the user command input unit 510 can receive a user command from external input means (such as a remote control). If it determines that the user has made a GUI request, the main processor 506 checks whether or not there is any signal source connected to the signal sink 500 (602). As described above, the signal source may include a plurality of devices although it may include only one device as described above. Consequently, at step 602, the main processor 506 checks the connection states of all devices connected to the main processor 506. In order to assist the main processor 506 with its functions, the auxiliary processor 508 receives a CEC frame (or a GUI frame) from the signal source 400 and header/data blocks of the received CEC frame to the main processor 506. The main processor 506 can check the state of connection of the main processor 506 with the corresponding device using a logical address included in the header of the CEC frame. It is preferable that each device have its unique logical address in order to allow the main processor 506 to check the connection state of the device using the logical address. The main processor 506 can use not only the logical address but also the physical address of the signal source in order to check the connection state of each corresponding device. The signal sink 500 can generate a physical address, which is included in a vendor-specific data block (VSDB), and transfer the physical address to a corresponding signal source and then check the connection state of the device using both the physical and logical addresses.

The main processor 506 outputs the checked results of the connection states of the devices to the GUI screen generator 512 (604). Using the checked results provided from the main processor 506, the GUI screen generator 512 generates a GUI screen showing the connection state of each device and outputs the generated GUI screen to the video/audio processor 514 (604). The video/audio processor 514 then displays the GUI screen, which has menu items showing the connection states of the devices, on the display unit 516 (604). If there is no device connected to the signal sink 500, the GUI screen generator 512 can generate an extra message (for example, “There is no connected device.”) as the GUI screen although it may generate a GUI having menu items indicating that there is no connected device (606).

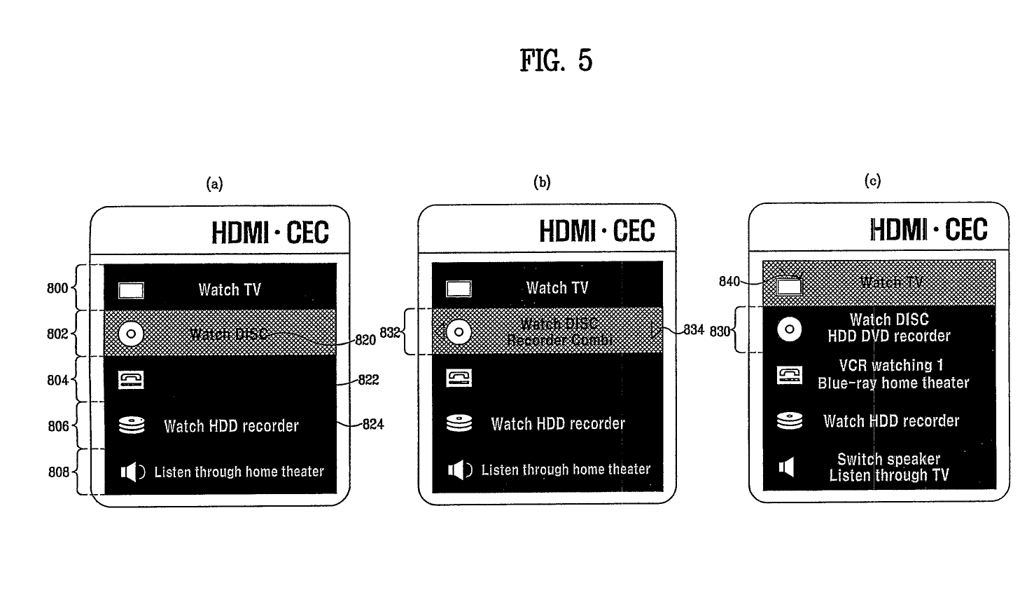

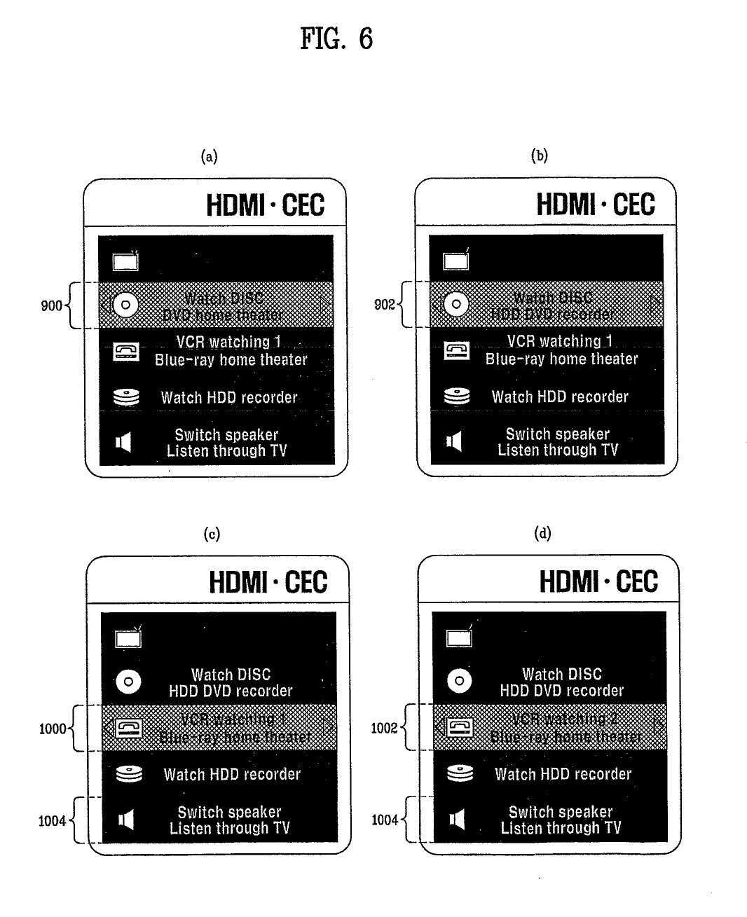

A method for generating GUI screens at the GUI screen generator 512 and the GUI screens will now be described with reference to FIGS. 5A to 5C and 6A to 6D.

FIGS. 5A to 5C show example GUI screens including menu items 800 to 808 corresponding to functions which can be selected by the user.

As shown in FIGS. 5A to 5C, each menu item of the GUI screen may be represented by at least one of an icon or a device name such as TV, DSIC, VCR, or HDD. Thus, the user can more easily recognize the connection states of the devices through the GUI screen.

Menu items corresponding to functions selectable by the user and menu items corresponding to functions not selectable by the user are displayed so as to be discriminated from each other. For example, as shown in FIG. 5A, characters of the menu items 800, 802, 806, and 808 corresponding to the functions selectable by the user can be processed to be displayed in bright colors (824) while characters of the item 804 not selectable by the user can be processed to be displayed in gray (822). When a signal source 400 having a device “HDD recorder” is connected to the signal sink 500, the menu item 806 displays bright characters indicating that the user can select the “watch HDD recorder” function. However, when a signal source 400 having a device “VCR” is not connected to the signal sink 500, the menu item 806 displays gray characters 822 indicating that the user cannot select the “watch VCR” function. According to another embodiment of the invention, menu items corresponding to functions selectable by the user are displayed in the GUI while menu items corresponding to functions not selectable by the user are not displayed in the GUI.

In the GUI screen, menu items corresponding to functions selected by the user and menu items corresponding to functions not selected by the user are displayed so as to be discriminated from each other. For example, as shown in FIG. 5A, the background color 820 of the menu item 802 corresponding to a function selected by the user is displayed differently from the background colors of the other menu items 800, 804, 806, and 808.

In the GUI screen, a menu item corresponding to function which is currently in operation and the other menu items are displayed so as to be discriminated from each other. For example, as shown in FIG. 5C, when a “watch TV” function is currently in operation, the menu item 800 may have a gull image 840 unlike the other menu items 802 to 808. Through the gull image 840, the user can recognize that the television is in operation.

In addition, when the same or different types of devices which provide the same functions are connected to a signal sink, menu items of the same function provided by the devices can be sequentially displayed according to selection of the user. For example, let us assume that different types of devices “Recorder Combi” and “HDD DVD recorder” provide the same function “watch DISC.” In this case, if the user operates a left/right key 830 shown in FIG. 5B using an external input means such as a mouse or a remote control, then the menu item 832 displayed is changed to a menu item 834 as shown in FIG. 5C.

FIGS. 6A to 6D illustrate example GUI screens for explaining how menu items of the same function are changed.

From FIGS. 6A to 6D, it can be seen that a gull image of a menu item corresponding to a currently-operating function “watch TV” is still displayed on the GUI even while a menu item 900 corresponding to a function selected by the user is displayed so as to be discriminated from menu items corresponding to functions not selected by the user by means of their background colors.

When there are different types of devices (for example, “DVD home theater” and “HDD DVD recorder”) connected to a signal sink, displayed menu items 900 and 902 of the same functions (for example, “watch DISC”) provided by the different types of devices are changed (from the menu item of FIG. 6A to that of FIG. 6B) when the user operates the left/right key as described above. When there are the same types of devices (for example, “blue-ray home theater”) connected to a signal sink, displayed menu items 1000 and 1002 of the same functions (for example, “VCR watching 1” and “VCR watching 2”) provided by the same types of devices are changed (from the menu item of FIG. 6C to that of FIG. 6D) when the user operates the left/right key as described above.

When the user operates the left/right key shown in FIG. 6C using a mouse or remote control, a menu item 1004 indicating “Listen through TV” in the “Switch speaker” function is changed to another menu item 1004 indicating “Listen through home theater” as shown in FIG. 6D. If the signal sink is connected to only one device which performs a specific function (for example, “watch HDD recorder” function), the menu item of the “watch HDD recorder” function has no left/right key as shown in FIGS. 5A to 5D.

There are various methods for operating GUI screens as shown in FIGS. 5A to 5C and FIGS. 6A to 6D using a remote control. The menu items can be scrolled to the left/right/top/down on the GUI screen by operating the left/right/top/down navigation key 534 shown in FIG. 3 and a desired menu item can be selected by pressing an OK button 536. The remote control may also include a cancel key 532 to turn the popup of a GUI screen on or off. The GUI screen may be designed to disappear from the display unit 516 when a hotkey 530 is pressed or when the user has not made any input until a specific time (for example, 40 seconds) has passed or when another menu (for example, TV Guide) is activated. Thus, various embodiments are possible for the method for operating GUI screens using a remote control.

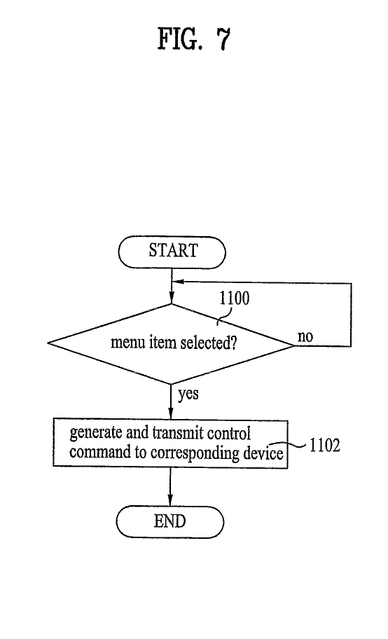

FIG. 7 is a flow chart illustrating a method for operating a signal sink.

The main processor 506 checks whether or not the user has selected a menu item displayed in a GUI screen using an external input means (1000). When a menu item has been selected, the main processor 506 generates a command for controlling a device which provides a function corresponding to the selected menu item and transmits the generated command to the corresponding device through the auxiliary processor 508 (1102).

Through the auxiliary processor 508, the main processor 506 determines whether the device which provides the function corresponding to the menu item which the user has selected on the GUI has been powered on or off. If it determines that the device has been powered off, the main processor 506 generates a signal for powering the device on and transmits the signal to the device through the auxiliary processor 508. After powering the corresponding device on, the main processor 506 causes the device to provide the function of the menu item selected by the user.

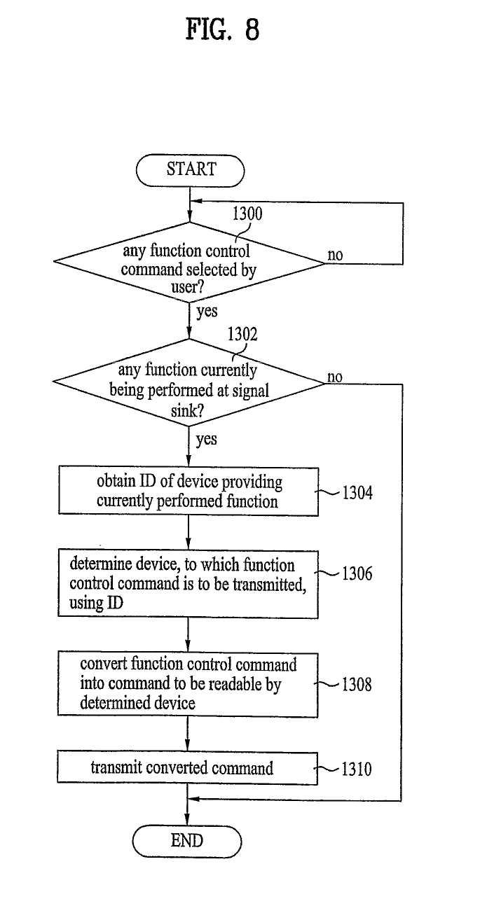

As described above, if the user selects a desired device on the GUI screen, the signal sink 500 performs a function provided by the selected device. Here, the signal sink 500 can transmit various types of function control commands to control the functions of the selected device 400. A signal sink which processes various types of function control commands and a method for operating the signal sink according to another embodiment of the invention will now be described with reference to FIG. 8 in conjunction with FIGS. 2 and 3 described above.

FIG. 8 is a flow chart illustrating a method for operating a signal sink according to the embodiment of the invention.

Although, for better understanding of the invention, the following description is given under assumption that the signal sink operating method shown in FIG. 8 is performed at the signal sink 500 shown in FIG. 2, the invention is not limited to this assumption.

The main processor 506 checks whether or not the user has input a function control command (1300). The function control command is a command that is requested by the user who desires to control the function of the device. The following Table 1 shows an example command table listing respective function control commands of device types in association with the corresponding device types. Here, the command table can be received and constructed from one or more devices.

TABLE 1

| Device Type | | Function Control Commands |
|---|---|---|
| DISC | DVD Player | Stop, Play, Pause, FF, RW, Previous, Next, |
| | | Up, Down, Left, Right, OK, Menu |
| | DVD Recorder | Stop, Play, Pause, Recording, FF, RW, |
| | | Previous, Next, Up, Down, Left, Right, OK, |
| | | Menu |
| | Home Theater | Stop, Play, Pause, Recording, FF, RW, |
| | | Previous, Next, Up, Down, Left, Right, OK, |
| | | Volume up, Volume down, Mute, Menu |
| VCR | VCR | Stop, Play, Pause, Recording, FF, RW |
| HDD | HDD | Stop, Play, Pause, Recording, FF, RW, |
| | | Previous, Next, Up, Down, Left, Right, OK, |
| | | Volume up, Volume down, Mute, Menu |

In Table 1, Stop is a stop command for a corresponding function, Play is a play command for a corresponding function, Pause is a pause command for a corresponding function, Recording is a recording command for a corresponding function, FF is a fast-forward command for a corresponding function, RW is a rewind command for a corresponding function, Previous, Next, Up, Down, Left, and Right are commands to select the positions of scenes displayed when a corresponding function is performed, OK is an OK command for a corresponding function, Volume up, Volume down, and Mute correspond respectively to a command to increase the volume of sound, a command to decrease the volume of sound, and a command to mute the sound played while a corresponding function is performed, Menu is a menu command for a corresponding function.

When the user selects a function control command, the user command input unit 510 shown in FIG. 2 outputs the selected function control command to the main processor 506. To accomplish this, the user command input unit 510 may be implemented in the form of a remote control including a number of function keys 540 to 548 as shown in FIG. 3 and may also be implemented in the form of a graphical user interface. The user can select various function control commands as shown in Table 1 by pressing the button-like function keys 540 to 548.

When the main processor 506 receives a function control command from the user command input unit 510 as the user selects the function control command, the main processor 506 checks whether or not any function is currently being performed at the signal sink 500 (1302). If a function is currently being performed at the signal sink 500, the main processor 506 checks and obtains an ID (for example, a logical address) of a device which provides the currently performed function (1304). After the step 1304, the main processor 506 determines that the checked device is to receive the function control command (1306).

In the invention, the type of a device providing a function which the user desires to control is not selected by the user command input unit 510. Instead, as can be seen from FIG. 8, the signal sink 500 itself identifies the device providing the function which the user desires to control by performing steps 1304 and 1306 even though the function control command input by the user cannot be read at the device providing the function that is currently being performed at the signal sink 500. This is because the main processor 506 not only has previously listed and read the logical addresses of all the devices of signal sources connected to the signal sink 500 but also generates, when a menu item is selected through the user command input unit 510, a command to control a device providing a function corresponding to the selected menu item.

The main processor 506 converts the function control command into a command format readable by the device determined at step 1306 (1308). According to the invention, the function control command provided from the user command input unit 510 may have no relation with the type of a device to which the function control command is to be transmitted. Accordingly, the main processor 506 encodes and converts the function control command so as to be readable by the device determined at step 1306. For example, using the command table as shown in Table 1, the main processor 506 checks whether or not the function control command selected by the user corresponds to the type of the device determined at step 1306. If the function control command does not correspond to the type of the device determined at step 1306, the main processor 506 can notify the user of the fact by providing a message through the video/audio processor 514, the display unit 516, and/or the speaker 518 or can determine that it is an unexecutable function control command. For better understanding of step 1308, let us assume that a VCR function is being performed through the signal sink 500. Here, although the user has selected a function control command “Volume up”, the (VCR) function performed at the signal sink 500 cannot be controlled according to the function control command “Volume up” and therefore the main processor 506 can notify the user of the fact using a message.

After step 1308, the auxiliary processor 508 transmits the converted command received from the main processor 506 to the signal source having the device determined at step 1306 via the HDMI-CEC line 520 (1310).

Although the user can select and connect a device on the GUI screen according to the method shown in FIGS. 4 and 7, the user can manually select and connect a device to the signal sink after checking connections between the ports and the various devices. The signal sink operating method according to the invention shown in FIG. 8 can also be usefully applied in this case.

A computer-readable recording medium includes any type of storage device that stores data readable by a computer system. Examples of the computer-readable recording medium include a ROM, RAM, CD-ROM, magnetic tape, floppy disk, and optical data storage. The computer-readable recording medium also includes one implemented in the form of a carrier wave (for example, transmission over the Internet). The computer-readable recording medium can also be distributed over a network of connected computer systems such that the computer-readable code is stored and executed in a distributed fashion. Such functional program, codes, and code segments for implementing the user tracking method can be easily inferred by programmers in the art of the invention.

The preferred embodiments of the present invention have been disclosed for illustrative purposes. Thus, those skilled in the art will appreciate that various other embodiments can be provided by making various improvements, modifications, substitutions, or additions to the disclosed embodiments without departing from the scope and spirit of the invention as disclosed in the accompanying claims.

### Mode for Invention

Various embodiments have been described above in the above Best Mode section.

### INDUSTRIAL APPLICABILITY

The invention allows the user to easily control the function of a device that is currently being performed at a signal sink through a simple functional key operation without selecting the type of the device.

1. A method for operating a signal sink that is connected to one or more devices through an HDMI scheme, the method comprising: receiving a function control command from a user; determining that a device providing a function, which is being currently performed at the signal sink, is a device to which the function control command is to be transmitted; and converting the function control command to a command readable by the determined device.

2. The method according to claim 1, wherein the function control command received from the user is not readable by the device providing the function which is being currently performed at the signal sink.

3. The method according to claim 1, further comprising transmitting the converted function control command to the determined device through an HDMI-CEC line.

4. The method according to claim 1, wherein the
determining step includes: checking, when receiving the function control command from the external input means, whether or not any function is currently being performed at the signal sink;
identifying, when a function is currently being performed at the signal sink, a device which provides the currently performed function; and determining that the identified device is a device to which the function control command is to be transmitted.

5. The method according to claim 4, wherein the step of identifying the device includes checking an ID of the device that provides the currently performed function.

6. The method according to claim 1, wherein the step of converting the function control command to the command readable by the determined device includes: encoding the function control command using a command table, in which each type of the one or more devices is associated with corresponding transmittable function control commands, and outputting the encoded command as the readable command.

7. The method according to claim 6, wherein the command table is received and constructed from the one or more devices.

8. A computer-readable recording medium wherein a program for performing the method according to claim 1 is recorded.

9. A signal sink that is connected to one or more devices through an HDMI scheme, the signal sink comprising: a user command input unit that receives a function control command from a user; and a main processor that identifies a device providing a function, which is currently being performed at the signal sink, in response to receiving the function control command, determines that the identified device is a device to which the function control command is to be transmitted, and converts the function control command to a command readable by the determined device.

10. The signal sink according to claim 9, wherein the function control command received from the user is not readable by the device providing the function which is being currently performed at the signal sink.

11. The signal sink according to claim 9, further comprising an auxiliary processor for transmitting the converted function control command received from the main processor to the determined device.

12. The signal sink according to claim 9, wherein the main processor encodes the function control command using a command table, in which each type of the one or more devices is associated with corresponding transmittable function control commands, and outputs the encoded command as the readable command.

13. The signal sink according to claim 12, wherein the main processor receives and constructs the command table from the one or more devices.

14. A computer-readable recording medium wherein a program for performing the method according to claim 2 is recorded.

15. A computer-readable recording medium wherein a program for performing the method according to claim 3 is recorded.

16. A computer-readable recording medium wherein a program for performing the method according to claim 4 is recorded.

17. A computer-readable recording medium wherein a program for performing the method according to claim 5 is recorded.

18. A computer-readable recording medium wherein a program for performing the method according to claim 6 is recorded.

19. A computer-readable recording medium wherein a program for performing the method according to claim 7 is recorded.
